(19) United States
(12) Patent Application Publication
(10) Pub. No.: US 2017/0002899 A1
(43) Pub. Date: Jan. 5, 2017

(54) TRANSMISSION AND METHOD FOR OPERATING SAME

(71) Applicant: RICARDO DEUTSCHLAND GMBH, Schwaebisch Gmuend (DE)

(72) Inventor: GUENTHER MATTHIAS PRIWITZER, Bietigheim-Bissingen (DE)

(73) Assignee: RICARDO DEUTSCHLAND GMBH, Schwaebisch Gmuend (DE)

(21) Appl. No.: 15/100,230

(22) PCT Filed: Nov. 24, 2014
(86) PCT No.: PCT/EP2014/075386

§ 371 Date: May 27, 2016

(30) Foreign Application Priority Data
Nov. 29, 2013 (EP) 13195138.6

(51) Int. Cl. F16H 3/093; F16H 3/00

(52) U.S. Cl. CPC F16H 3/093; F16H 3/006; F16D 11/00

(57) ABSTRACT

A transmission is disclosed which has at least two component transmissions and which are shiftable independently of one another, and where the transmission has a friction clutch; first and second transmission input shafts; and a transmission output shaft which can be brought into connection with an engine output shaft by means of a form-fitting force actuating shifting element.

The invention relates to a transmission having at least two component transmissions which have respective component transmission shafts and are shiftable independently of one another, and to a method for operating such a transmission.

A very wide variety of types of transmission are known from the general prior art. Said transmissions extend from transmissions to be shifted manually over automatically shifting transmissions to double clutch transmissions or automatic converter transmissions.

An example of a double clutch transmission is described in DE 198 53 824 A1. Said double clutch transmissions were originally developed in order to provide a cost-effective alternative to the automatic converters which constitute the majority of automatic transmissions up to now.

However, double clutch transmissions have various disadvantages, wherein the high structural outlay should be mentioned first and foremost. As a result of the fact that, during the normal driving mode, when the gears are engaged in the two component transmissions, one clutch always has to be kept open and the other clutch closed, hydraulic pumps having a very high volumetric flow are required for the actuation and lubrication, which, in addition to the structural outlay, also reduces the efficiency of the vehicles equipped with such a double clutch transmission since the continuous volumetric flow causes an additional consumption of fuel.

A further disadvantage of the known double clutch transmissions resides in the complicated construction of the clutches since the latter have to be capable of transferring from the open into the closed state and vice versa within fractions of a second. Since it has to be avoided under all circumstances that the two clutches are in their closed state when the gears are engaged, the actuating elements provided for changing over the clutches also have to be designed in a correspondingly reliable manner. In actual fact, the series manufacturing of said clutches, in particular if they are intended to be designed as dry clutches, has proven to be a very great challenge, and therefore only very few companies are actually capable of producing said clutches in series.

The circumstances have led, contrary to the original objective, to the prices of double clutch transmissions not being considerably less than those of automatic converter transmissions.

Despite this high outlay, double clutch transmissions still do not always reach the switching performance of converter transmissions in various sectors. For example, by dividing the transmission into two component transmissions, from the fourth shifting step a shift can be made only into the third or fifth shifting step, but not into the second shifting step, which may lead to problems, for example when approaching junctions, if it were necessary per se to downshift two shifting steps in order to obtain the desired acceleration.

DE 103 38 558 A1 describes a transmission of the type in question and a corresponding method. DE 199 24 501 A1 also presents similar prior art. However, the known proposals do not take into account the phase of transferring the drive via the friction clutch to direct drive and back to the friction clutch, which is therefore in particular problematic since, in this phase, two shifts at the same time are necessary, namely the ending of the direct drive and the engagement of the clutch. This may lead to considerable problems during the operation of these transmissions. For these reasons, these proposals are not suitable for series use and therefore have not been pursued further in practice.

Further transmissions which are shiftable without traction force interruption are described, for example, in JP 60 57033 A, DE 958 081 C and JP 2005 195115 A.

It is an object of the present invention to provide a transmission which has a good shifting performance, can be produced with relatively little outlay and at relatively favorable costs and is suitable for series use.

According to the invention, this object is achieved by the features cited in claim 1.

In the case of the transmission according to the invention, one of the at least two transmission input shafts therefore bypasses the friction clutch and is connected directly to the engine output shaft. As a result, only one friction clutch is required and, in comparison to the known double clutch transmissions, one friction clutch can be dispensed with. This constitutes a substantial simplification of the transmission according to the invention, and therefore said transmission can be produced substantially more cost-effectively than known double clutch transmissions or automatic converter transmissions. Nevertheless, a high shifting comfort can be achieved with the transmission according to the invention since, with an appropriate configuration, as good as no traction force interruption occurs during the shifting operations.

Furthermore, in contrast to known double clutch transmissions, a complicated actuator arrangement can be dispensed with since it is not required to continually keep the friction clutch open. This also gives rise to safety advantages since, in the known solutions, if an actuator arrangement keeping the friction clutch in the open state fails, two gears could be shifted simultaneously, which, in turn, could cause severe damage. In addition, a further advantage of the solution according to the invention resides in the fact that, by dispensing with corresponding hydraulic pumps, the consumption of fuel can also be reduced.

Owing to the fact that, according to the invention, form-fitting, force-actuated shifting elements are used in order to bring the transmission output shaft into operative connection with the engine output shaft via at least one of the component transmission shafts, a solution which is practical and is suitable for series use is achieved, which solution can also be realized in a highly cost-effective manner in comparison to known solutions. Furthermore, this solution ensures that the shifting elements are deactivated as soon as the actuating force is removed, and therefore the corresponding gear step is automatically disengaged or released. As a result, it is reliably prevented that, in the two component transmissions, two different gear steps are engaged and are connected to the engine output shaft or to the transmission output shaft, which otherwise could lead to considerable damage of the transmission or to a deterioration in the safety in traffic.

In an advantageous development of the invention, it can be provided that the individual gear steps of at least the second component transmission are assigned respective form-fitting, force-actuated shifting elements. As a result, the individual gear steps can be engaged in a very simple manner and are automatically disengaged or deactivated when the gear is changed. Furthermore, the structural outlay of the transmission can thereby be kept within limits, and therefore the costs of said transmission can be reduced further.

If, in another development of the invention, it is provided that the second transmission input shaft can be brought into operative connection with the at least two component transmission shafts via respective transmission means and form-fitting, force-actuated shifting elements which are operatively connected thereto, a further possibility is produced, which can be realized in a very simple and cost-effective manner, for using the form-fitting and force-actuated shifting elements which bring the transmission output shaft into operative connection with the engine output shaft. By means of the transmission means and the shifting elements which are in operative connection therewith, the second transmission input shaft, which is directly connected to the engine output shaft, can be connected in a very simple manner to the desired component transmission, with it being possible, in turn, for the shifting elements to be designed in a relatively simple and therefore cost-effective manner.

Furthermore, it can be provided, according to the present invention, that the transmission means are designed as gear pairs. Gear wheels are components which are introduced in the construction of transmissions and operate extremely reliably.

An equally structurally simple and reliable embodiment of the form-fitting shifting elements is produced if the latter are designed as claw clutches.

In this connection, an embodiment which is very reliable and can be produced in a simple manner can consist in that the form-fitting shifting elements have two clutch halves with projections and recesses engaging in the projections.

A development of the invention that is highly advantageous in respect of the automatic opening of the form-fitting shifting elements is produced if the projections taper in the direction of the recesses.

If, furthermore, those sides of the projections which face the recesses have an angle of 3-45° on the tension side of the shifting element, simple actuation and reliable opening of same is ensured.

A structurally simple possibility for the mutual arrangement of the first and the second transmission input shaft is produced if said transmission input shafts are arranged coaxially one in the other.

A further advantageous refinement of the invention can consist in that three or more component transmissions are provided with respective component transmission shafts, wherein the second transmission input shaft can be brought into operative connection with the three or more component transmission shafts via respective transmission means and shifting elements in operative connection therewith. In the case of such an embodiment of the transmission, firstly a greater number of gear steps can be realized, and, secondly, because of the greater number of component transmissions, a greater selection of gear steps, into which the transmission can be shifted during a change of gear, is possible. This leads to greater variation possibilities for an imminent or planned change of gear since, in contrast to known double clutch transmissions, gears may also be skipped.

In a further advantageous refinement of the invention, it can be provided that the two transmission input shafts are each connected to at least two additional transmission means which have different transmission ratios. By means of these at least two additional transmission means which have different transmission ratios, the number of gear steps to be shifted can be doubled, which can afford considerable advantages in particular when the transmission according to the invention is used in commercial vehicles.

An achievement of the object in terms of method is specified in claim 12.

According to the method according to the invention, in the phase in which another gear is engaged in the component transmission connected to the friction clutch, the drive therefore takes place via the rigid or direct connection of the second transmission input shaft to the engine output shaft. During the closing of the friction clutch, which is used in the shifting operations essentially to compensate for the difference in rotational speed between two gear steps to be shifted, the gear step engaged in the component transmission, which is connected directly to the engine output shaft, is disengaged. During each shifting operation, a change takes place here from the direct connection to the connection via the friction clutch. Depending on the design of the at least two component transmissions, it may even be possible here to change from one gear step into any other gear step. During the direct drive of the engine output shaft via at least one of the component transmission shafts by means of the form-fitting, force-actuated shifting elements, the shifting elements are acted upon with a suitable actuation force. After the actuation force ceases, the shifting elements are deactivated. Although it would be possible in principle to operate the transmission output shaft directly, i.e. by bypassing the friction clutch, for longer than only during the shifting operation, this is not required.

In an advantageous development of the method according to the invention, it can be provided that directly after a shifting operation and the engagement of a gear step in the component transmission connected directly to the engine output shaft, the friction clutch is opened and the transmission output shaft is driven exclusively via the transmission input shaft which is connected directly to the engine output shaft. As a result, it is possibly possible to achieve a more rapid shifting time and to protect the friction clutch.

Alternatively thereto, it can be provided that a gear step is engaged in the component transmission, which is connected directly to the engine output shaft, only immediately before a shifting operation, and in that, directly after a shifting operation in the component transmission which is connected directly to the engine output shaft, the gear step is disengaged. In this procedure, it is not required to actuate the shifting element assigned to the respective gear step in order to ensure that the respective gear step is not released automatically.

Exemplary embodiments of the invention are illustrated in principle below with reference to the drawing.

In the drawing:

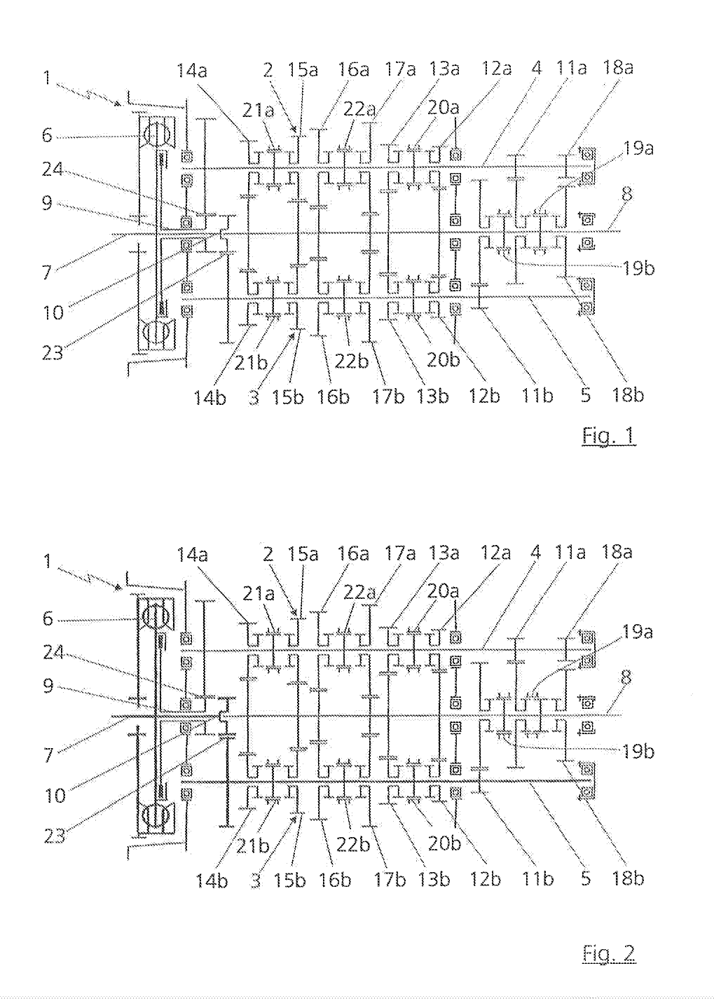

FIG. 1 shows a first embodiment of the transmission according to the invention in a first shifting state;

FIG. 2 shows the transmission from FIG. 1 in a second shifting state;

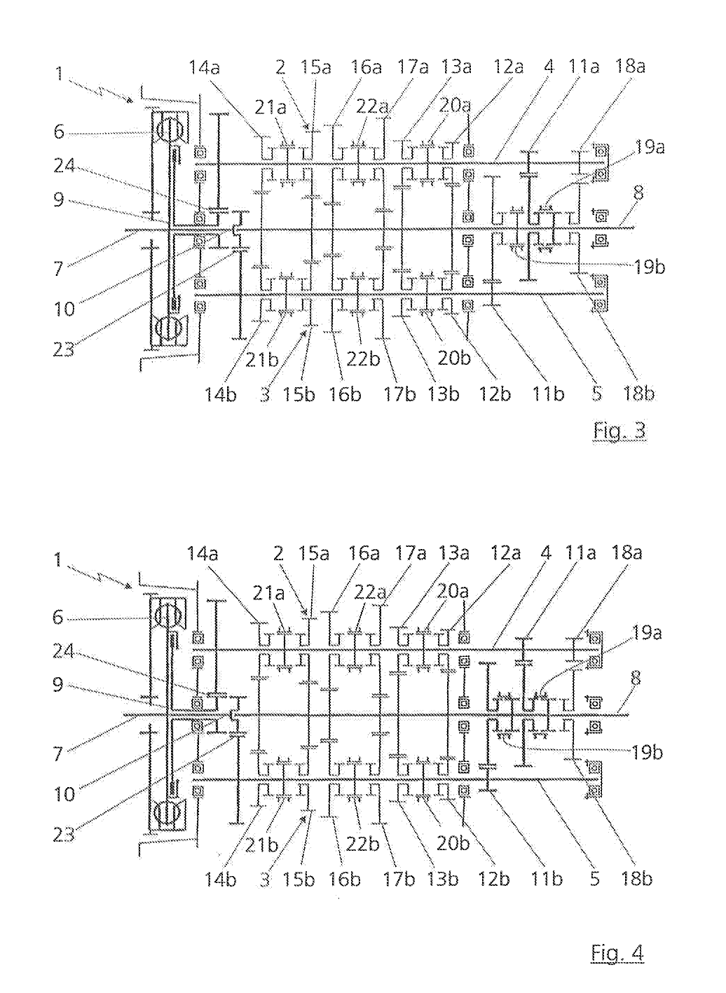

FIG. 3 shows the transmission from FIG. 1 in a third shifting state;

FIG. 4 shows the transmission from FIG. 1 in a fourth shifting state;

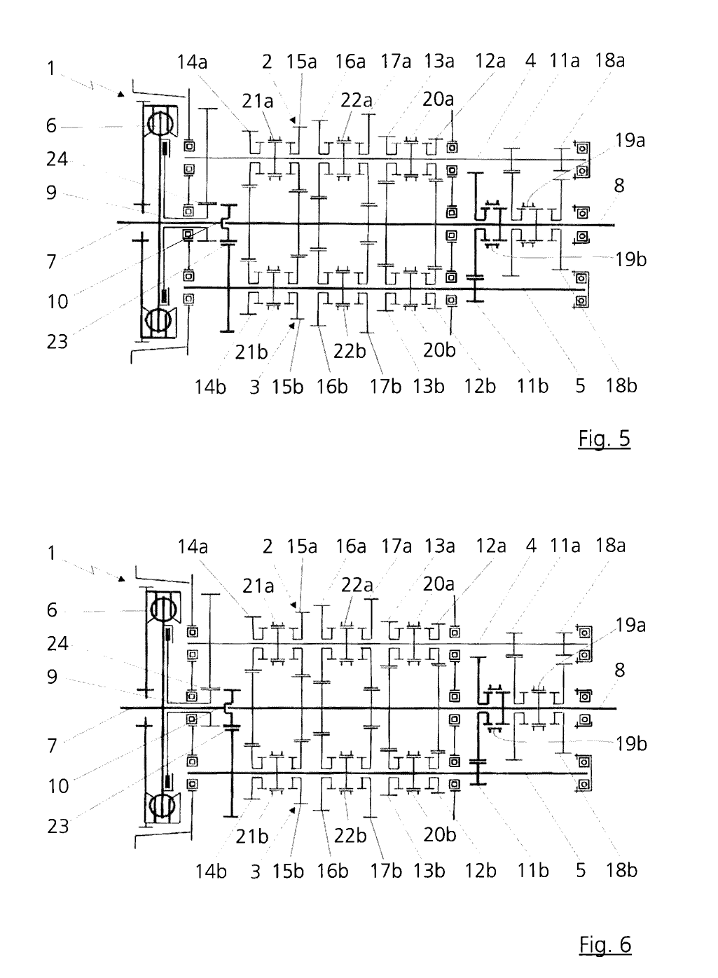

FIG. 5 shows the transmission from FIG. 1 in a fifth shifting state;

FIG. 6 shows the transmission from FIG. 1 in a sixth shifting state;

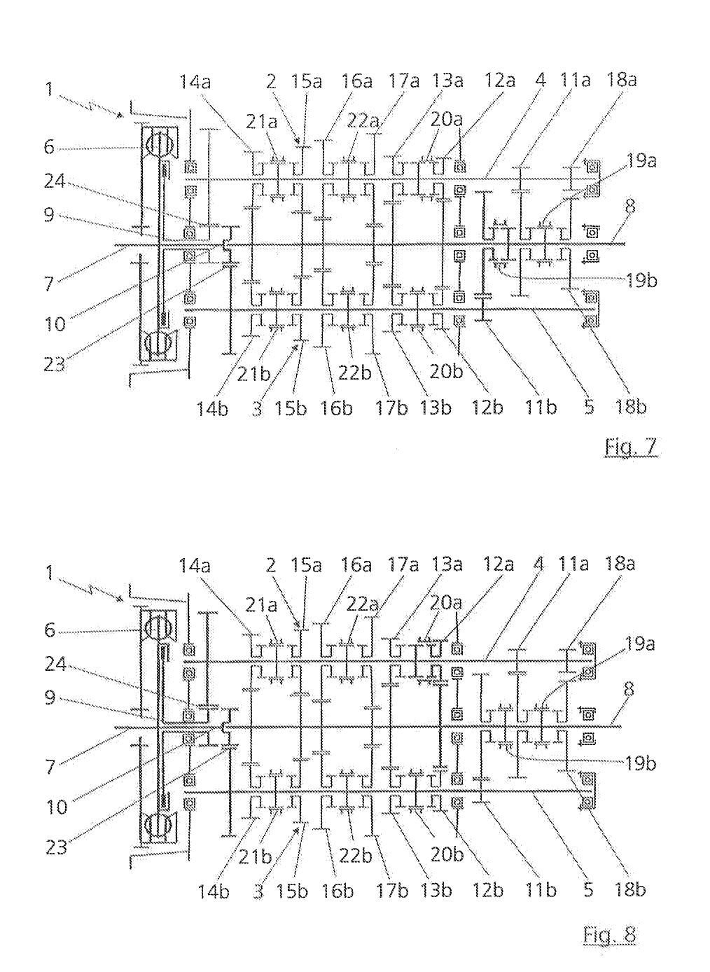

FIG. 7 shows the transmission from FIG. 1 in a seventh shifting state;

FIG. 8 shows the transmission from FIG. 1 in an eighth shifting state;

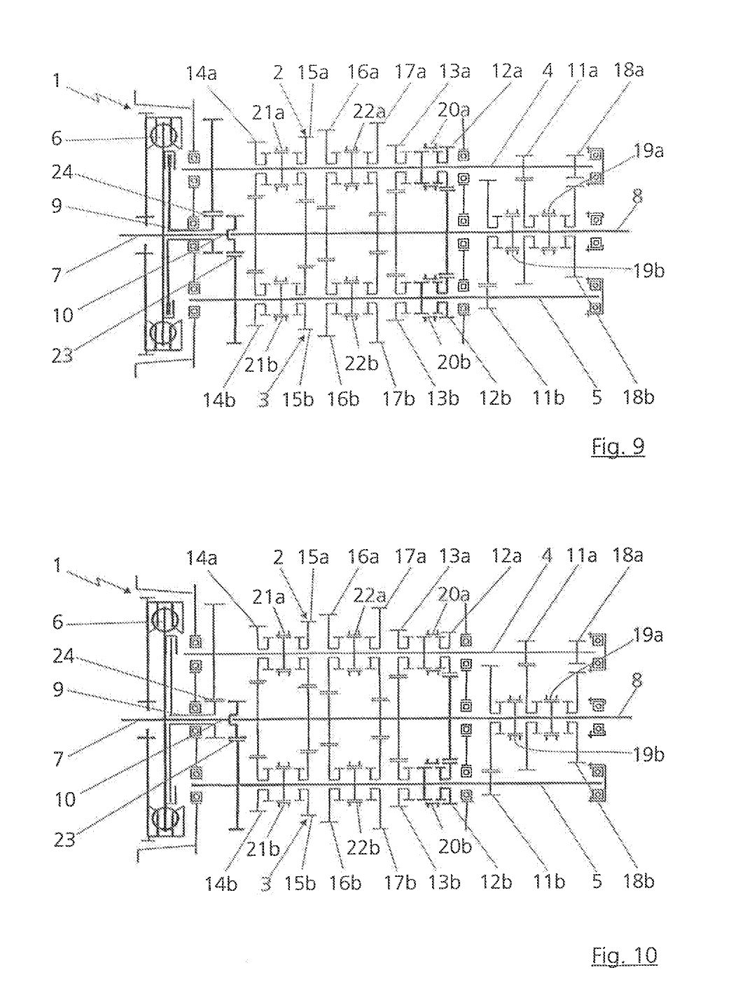

FIG. 9 shows the transmission from FIG. 1 in a ninth shifting state;

FIG. 10 shows the transmission from FIG. 1 in a tenth shifting state;

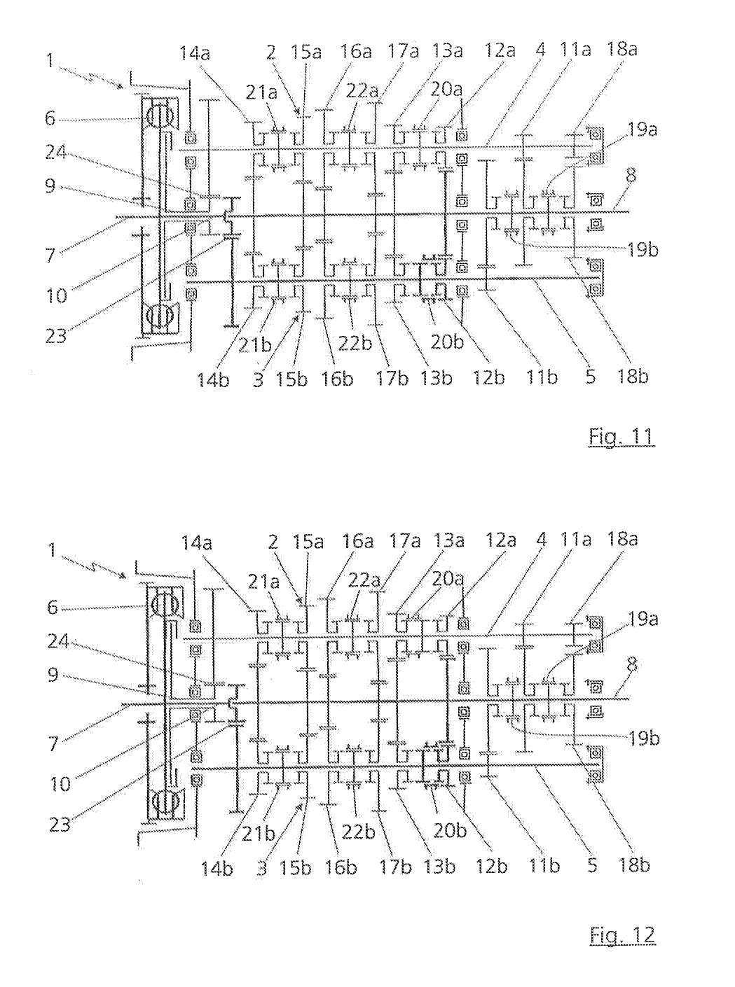

FIG. 11 shows the transmission from FIG. 1 in an eleventh shifting state;

FIG. 12 shows the transmission from FIG. 1 in a twelfth shifting state;

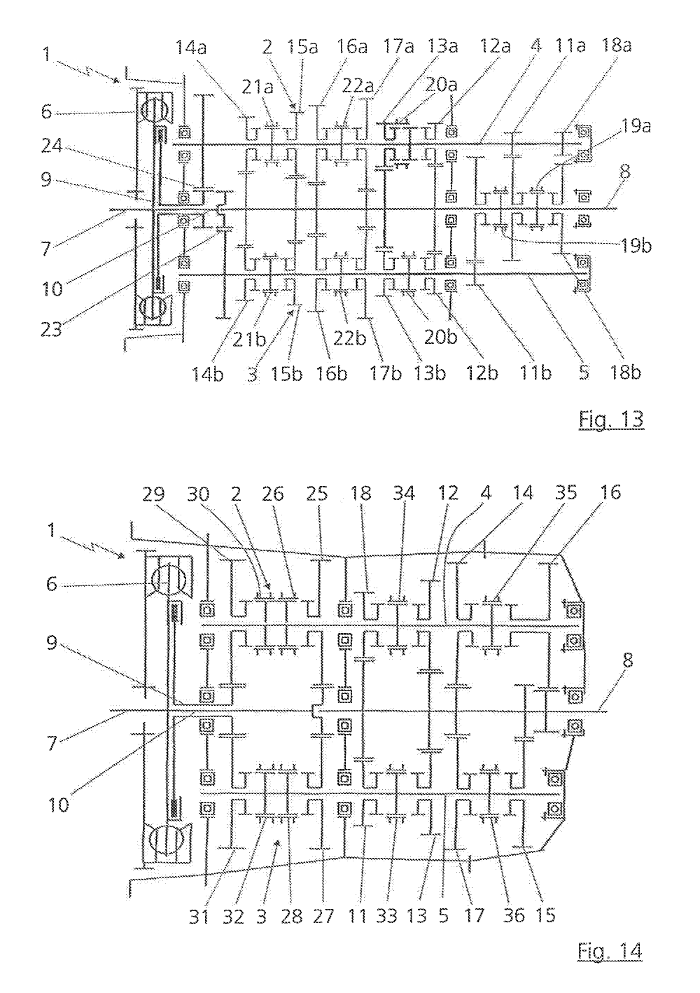

FIG. 13 shows the transmission from FIG. 1 in a thirteenth shifting state;

FIG. 14 shows a second embodiment of the transmission according to the invention in a first shifting state;

FIG. 15 shows the transmission from FIG. 14 in a second shifting state;

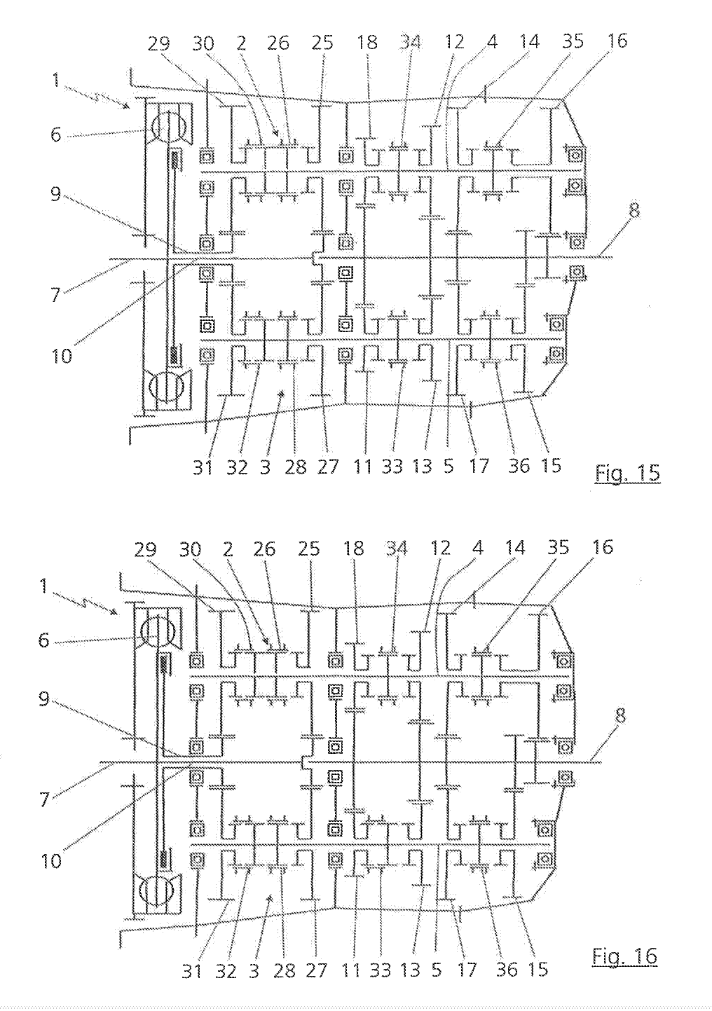

FIG. 16 shows the transmission from FIG. 14 in a third shifting state;

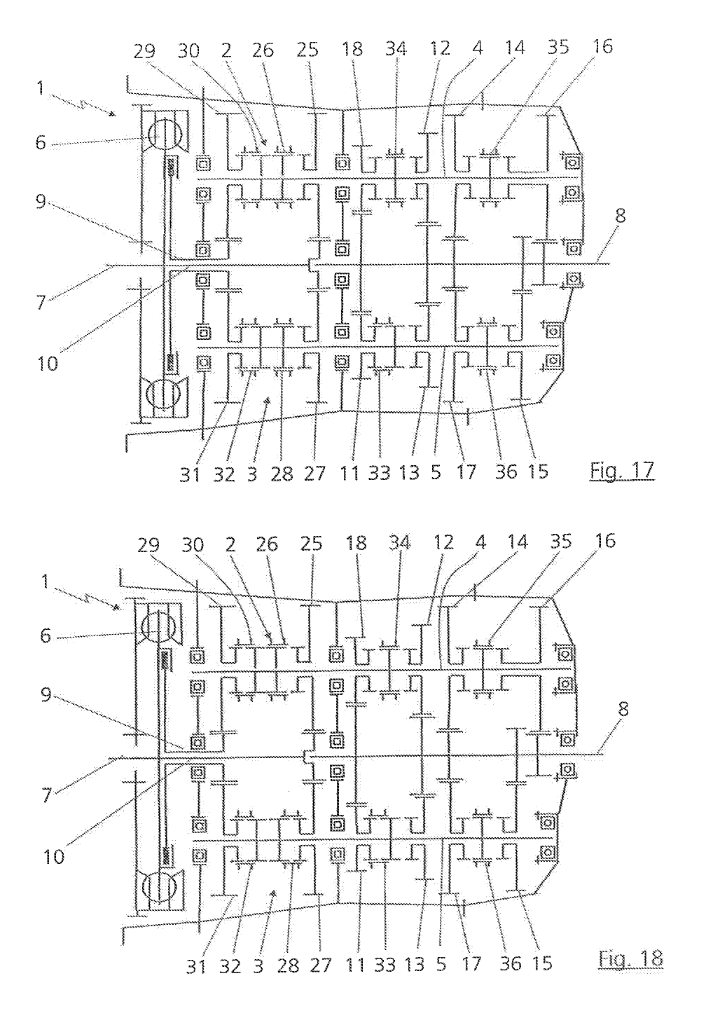

FIG. 17 shows the transmission from FIG. 14 in a fourth shifting state;

FIG. 18 shows the transmission from FIG. 14 in a fifth shifting state:

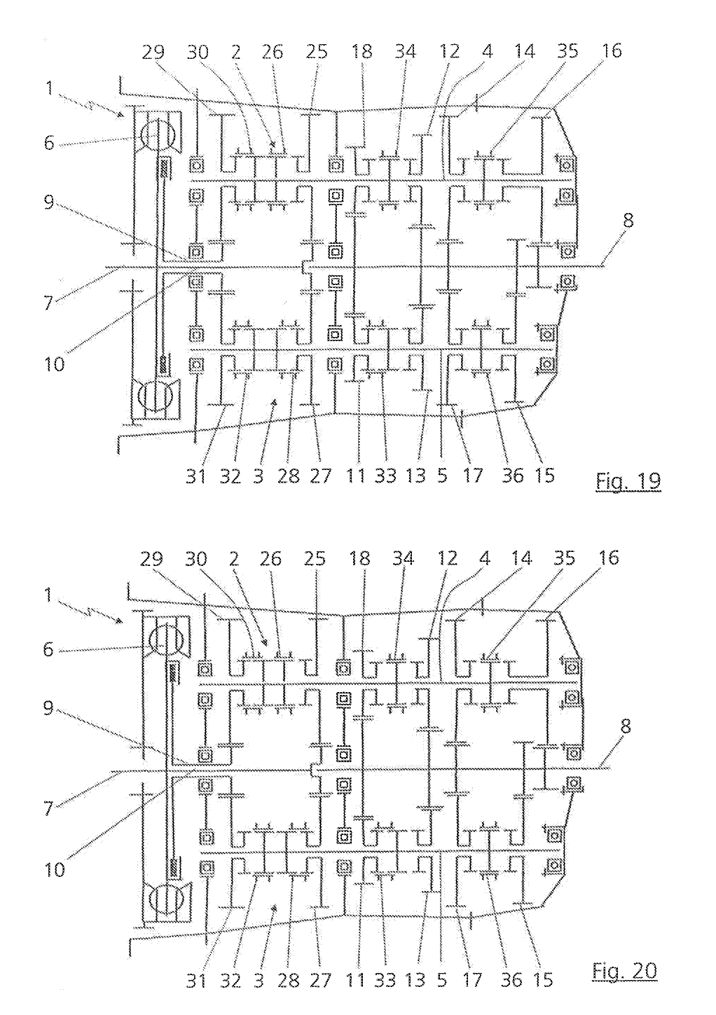

FIG. 19 shows the transmission from FIG. 14 in a sixth shifting state;

FIG. 20 shows the transmission from FIG. 14 in a seventh shifting state;

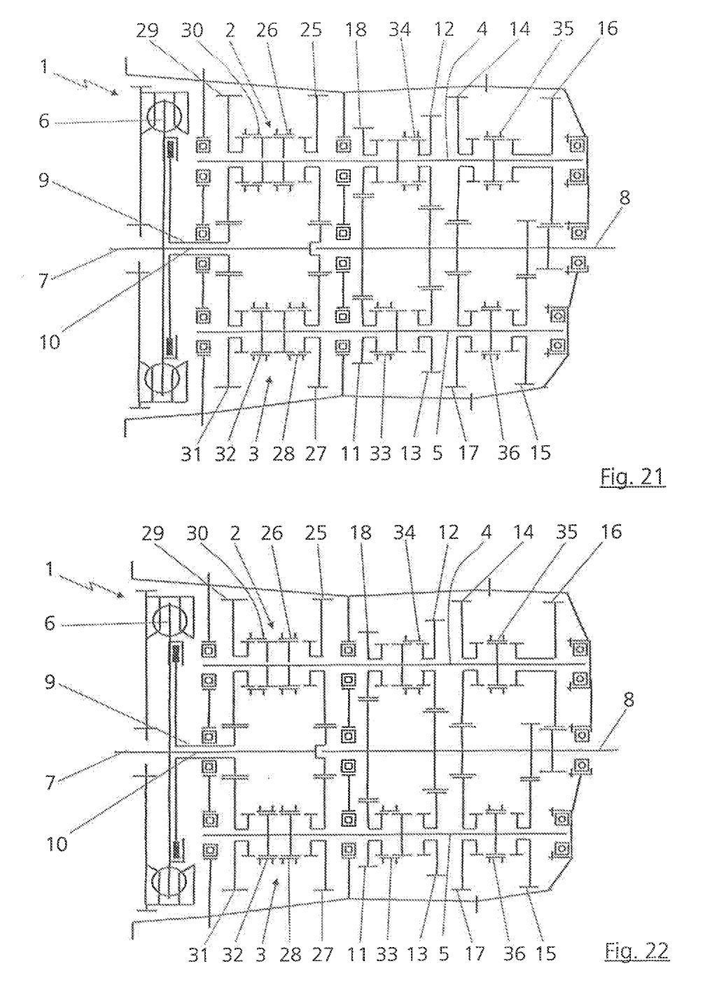

FIG. 21 shows the transmission from FIG. 14 in an eighth shifting state;

FIG. 22 shows the transmission from FIG. 14 in a ninth shifting state;

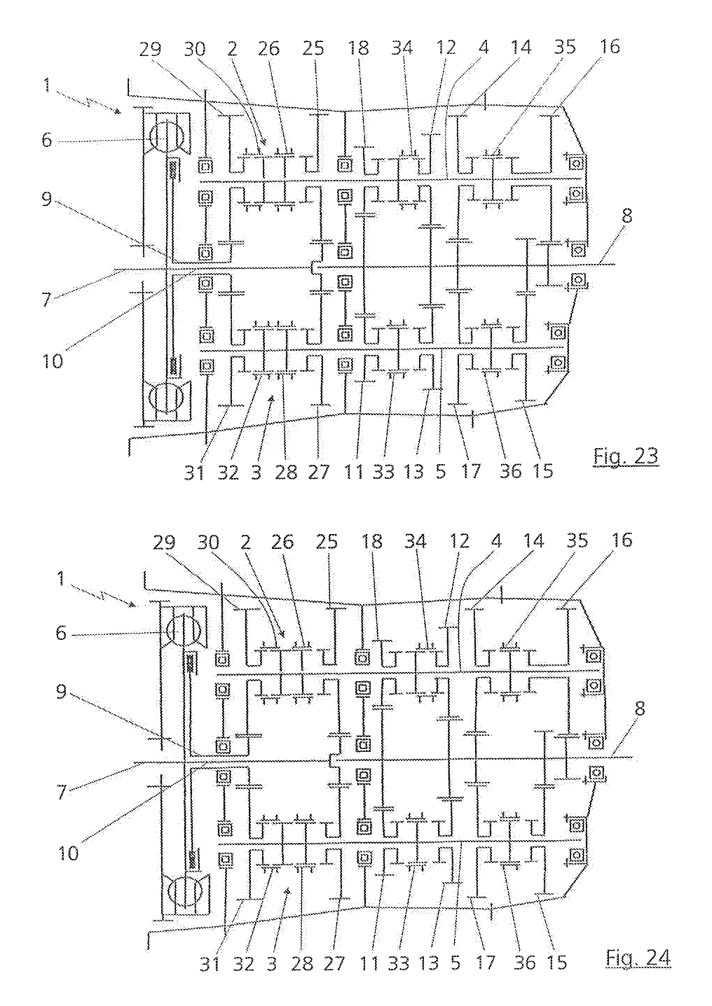

FIG. 23 shows the transmission from FIG. 14 in a tenth shifting state;

FIG. 24 shows the transmission from FIG. 14 in an eleventh shifting state;

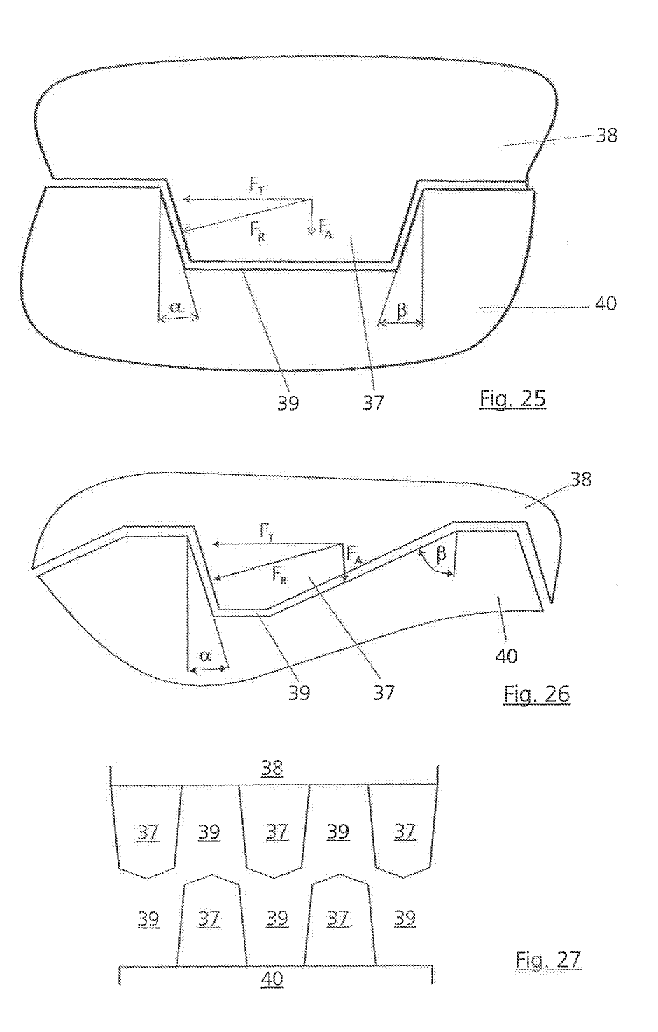

FIG. 25 shows a detail of a form-fitting shifting element in a first embodiment:

FIG. 26 shows a detail of a form-fitting shifting element in a second embodiment;

FIG. 27 shows a detail of a form-fitting shifting element in a third embodiment;

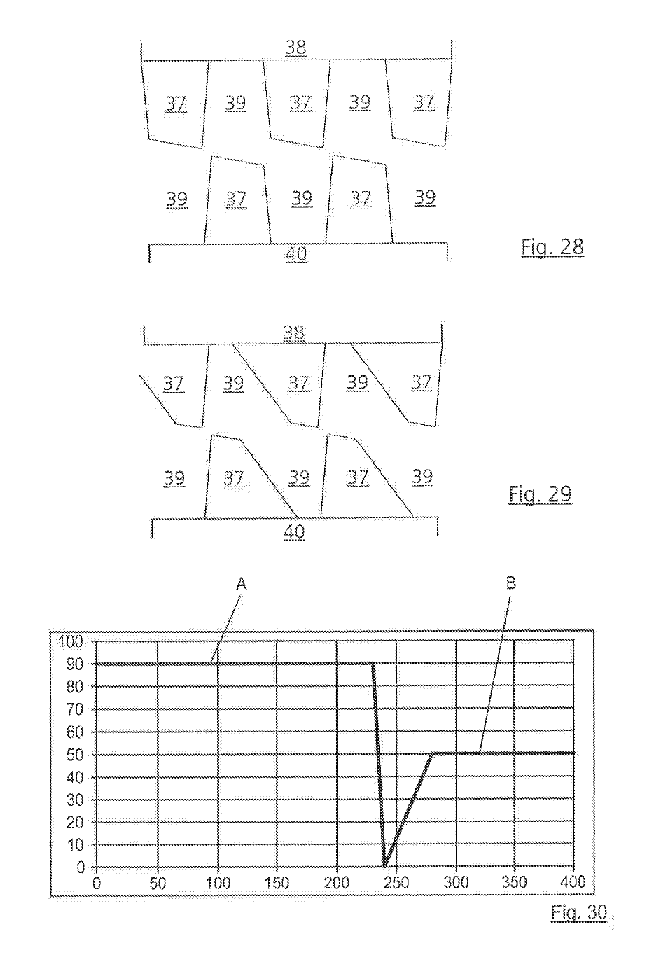

FIG. 28 shows a detail of a form-fitting shifting element in a fourth embodiment;

FIG. 29 shows a detail of a form-fitting shifting element in a fifth embodiment;

FIG. 30 shows a diagram in which a first illustrative torque profile during the up shifting is illustrated over time;

FIG. 31 shows a diagram in which a second illustrative torque profile during the up shifting is illustrated over time;

FIG. 32 shows a diagram in which a third illustrative torque profile during the up shifting is illustrated over time;

FIG. 33 shows a diagram in which a fourth illustrative torque profile during the up shifting is illustrated over time;

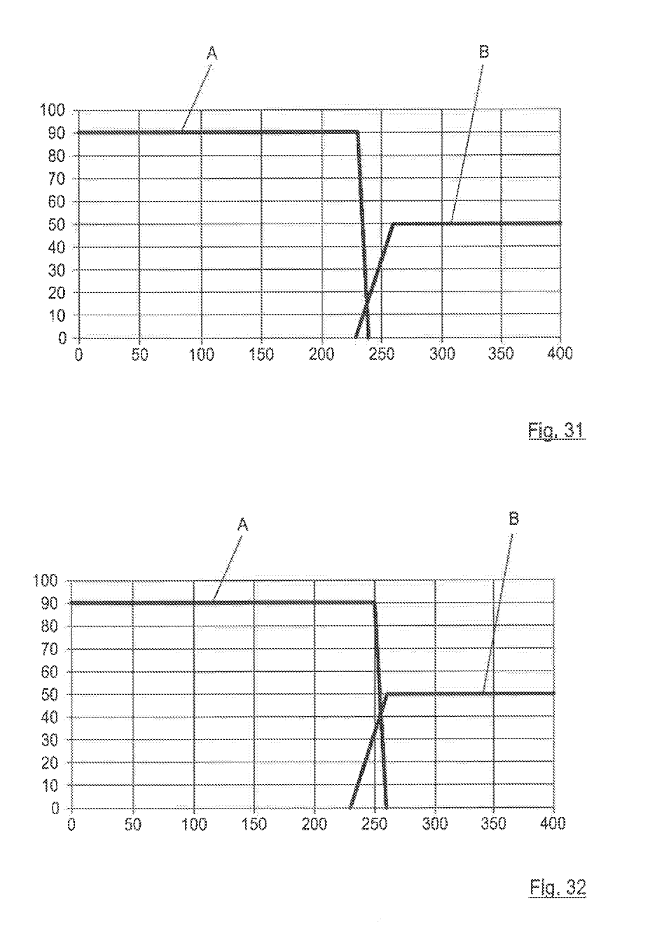

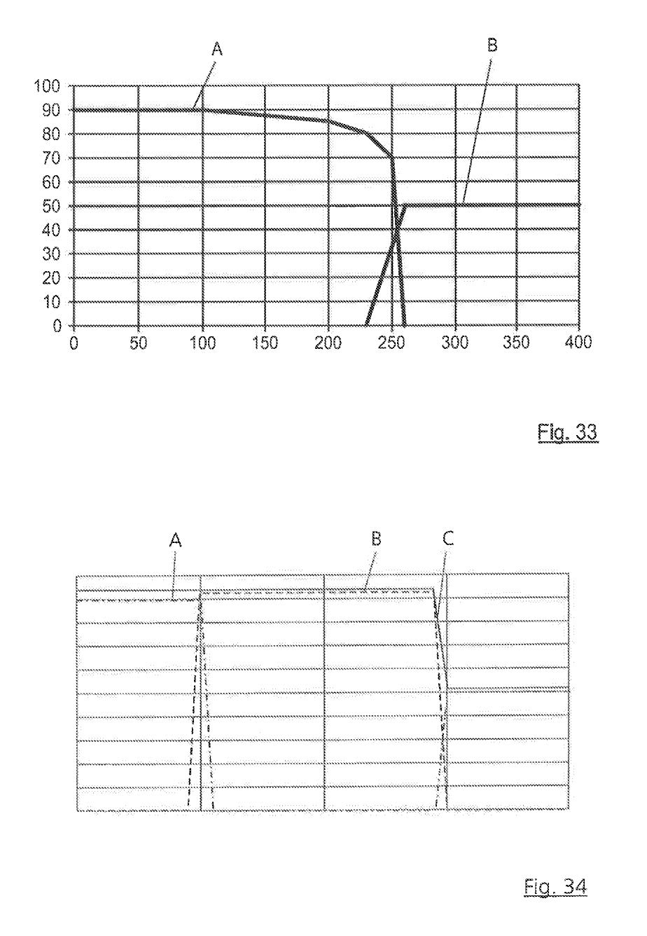

FIG. 34 shows a diagram in which a fifth illustrative torque profile during the up shifting is illustrated over time;

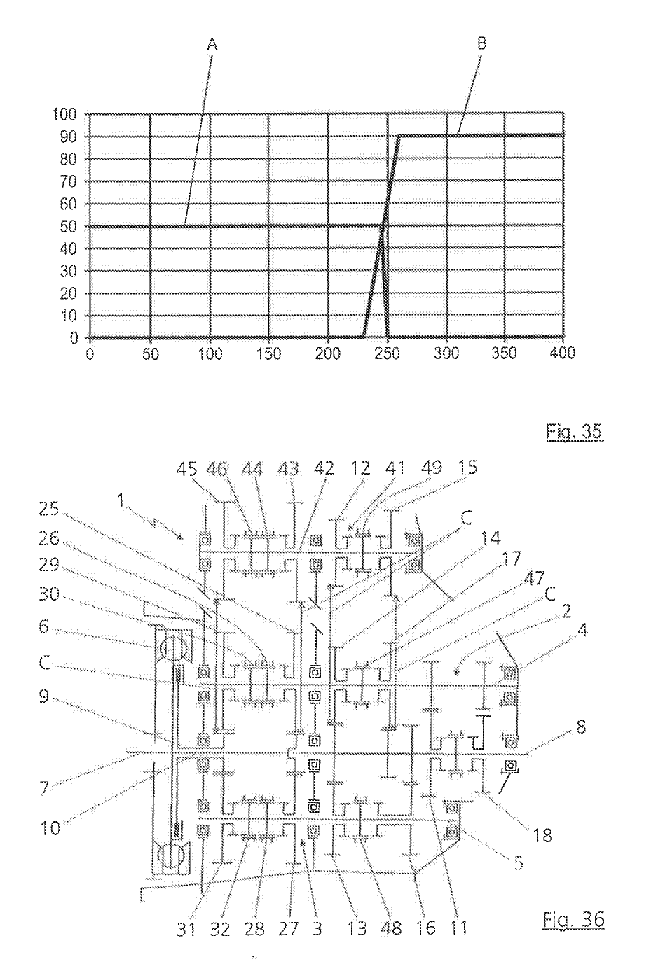

FIG. 35 shows a diagram in which a first illustrative torque profile during the down shifting is illustrated over time;

FIG. 36 shows a third embodiment of the transmission according to the invention;

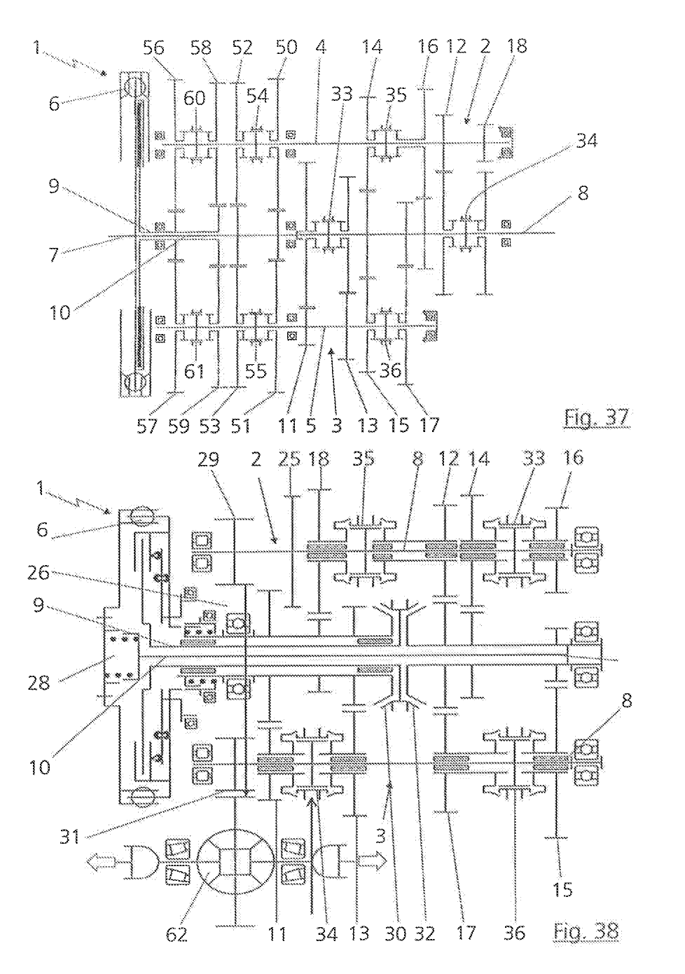

FIG. 37 shows a fourth embodiment of the transmission according to the invention; and

FIG. 38 shows a fifth embodiment of the transmission according to the invention.

FIG. 1 shows a first embodiment of a transmission 1 which, in the present case, has two component transmissions 2 and 3, which are referred to below as first component transmission 2 and second component transmission 3.

In FIGS. 1 to 13, which show various shifting states of the transmission 1, the first component transmission 2 is in each case illustrated at the top and the second component transmission 3 is in each case illustrated at the bottom, but this should be seen as being purely illustrative. The two component transmissions 2 and 3 have respective component transmission shafts 4 and 5 wherein the component transmission shaft 4 which is denoted by the reference sign 4 is assigned to the first component transmission 2 and is therefore also referred to below as the first component transmission shaft 4, whereas the component transmission shaft which is denoted by the reference sign 5 is assigned to the second component transmission 3 and is therefore also referred to below as the second component transmission shaft 5. As is explained in more detail below, the two component transmissions 2 and 3 are shiftable independently of each other, i.e. the respective gear steps of the two component transmissions 2 and 3 can be engaged independently of one another. In principle, it is therefore possible for in each case one gear step or one “gear” to be engaged in the two component transmissions 2 and 3.

The transmission 1 furthermore has a friction clutch 6 which, like all of the other components of the transmission 1, is illustrated only highly schematically in the figures and which serves to span the differences in rotational speeds, which occur during the change between two gear steps, between an engine output shaft 7 connected to the friction clutch and a transmission output shaft 8 which leads out of the transmission 1 and is connected in a manner not illustrated to a drive of a motor vehicle in which the transmission 1 is installed. The friction clutch 6 may be a multi-disk clutch, a dry clutch or another clutch formed in a manner known per se.

Furthermore, the transmission 1 has a first transmission input shaft 9 originating from the friction clutch 6, and a second transmission input shaft 10 which bypasses the friction clutch 6 and is directly connected to the engine output shaft 7. As emerges from the schematic illustration of FIG. 1, the second transmission input shaft 10 is arranged coaxially in the first transmission input shaft 9, which is designed as a hollow shaft. For the passage of the second transmission input shaft 10, the friction clutch 6 can be provided with a recess (not illustrated).

Although the bearings used for the mounting of the first component transmission shaft 4, the second component transmission shaft 5, the engine output shaft 7, the transmission output shaft 8, the first transmission input shaft 9 and the second transmission input shaft 10 are illustrated schematically in the figures, they are not described in detail and are also not provided with reference signs since they do not play an essential role in the invention.

A concept connecting all of the herein described embodiments of the transmission 1 consists in that the component transmission shaft 4 of the first component transmission 2 can be brought into operative connection with the first transmission input shaft 9 and/or with the second transmission input shaft 10, and that the component transmission shaft 5 of the second component transmission 3 can be brought into operative connection with the second transmission input shaft 10 and/or with the first transmission input shaft 9.

In the case of the embodiment of the transmission 1 that is illustrated in FIGS. 1 to 13, the engine output shaft 7 can be connected to the first component transmission shaft 4 of the first component transmission 2 via the friction clutch 6 and the first transmission input shaft 9 by closing the friction clutch 6. In the case in which the friction clutch 6 is open, this connection is interrupted. By contrast, the second component transmission shaft 5 of the second component transmission 3 is directly connected to the engine output shaft 7 continuously via the second transmission input shaft 10.

In the exemplary embodiment illustrated in FIGS. 1 to 13, the first component transmission 2 has seven gear steps for respective forward gears and one gear step for a reverse gear. The first gear step is denoted by the reference sign 11a, the second gear step by the reference sign 12a, the third gear step by the reference sign 13a, the fourth gear step by the reference sign 14a, the fifth gear step by the reference sign 15a, the sixth gear step by the reference sign 16a, the seventh gear step by the reference sign 17a and the gear step for the reverse gear by the reference sign 18a. The second component transmission 3 has the identical gear steps for the seventh forward gears and the reverse gear, which gear steps are denoted by the reference signs 11b to 18b. In the present case, the gear steps 11a to 18a and 11b to 18b each involve gear pairs in a manner known per se.

All of the gear steps 11a to 18a of the first component transmission 2 and all of the gear steps 11b to 18b of the second component transmission 3 are actuable by means of respective shifting elements. In this connection, the first gear step 11a is assigned a shifting element 19a, the second and third gear steps 12a and 13a are assigned a common shifting element 20a, the fourth and fifth gear steps 14a and 15a are assigned a common shifting element 21a, and the sixth and seventh gear steps 16a and 17a are assigned a common shifting element 22a. In the case of the second component transmission 3, the assignment of a shifting element 19b to the first gear step 11b, of a common shifting element 20b to the two gear steps 12b and 13b, of a common shifting element 21b to the two gear steps 14b and 15b, and of a common shifting element 22b to the two gear steps 16b and 17b takes place in a similar manner. The shifting elements 19a, 19b, 20a, 20b, 21a, 21b, 22a and 22b are each designed as form-fitting, force-actuated shifting elements which are deactivated when the actuating force actuating same ceases. For example, the form-fitting shifting elements 19a, 19b, 20a, 20b, 21a, 21b, 22a and 22b can be claw clutches, which is described in more detail at a later time with reference to FIG. 25.

Shifting operations for the transmission 1 having the two component transmissions 2 and 3, in which each component transmission 2 and 3 has all of the gear steps 1a to 18a and 11b to 18b, will now be described by way of example with reference to FIGS. 1 to 13.

FIG. 1 shows the inoperative state of the transmission, in which a gear step is not engaged in any of the two component transmissions 2 and 3.

By contrast, in the illustration of FIG. 2, the shifting element 19a assigned to the first gear step 11a of the first component transmission 2 is moved into its position actuating the first gear step 11a, and therefore, in the first component transmission 2, the first gear step 11a is engaged. By contrast, in the second component transmission 3, no gear is engaged. Since the friction clutch 6 is open, the engine output shaft 7 is not connected to the transmission output shaft 8, and no driving of the transmission output shaft 8 takes place. The changed position of the shifting element 19a is indicated by the fact that the shifting element 19a is illustrated by a bold line. Since the second component transmission shaft 5 is always connected to the engine output shaft 7, the engine output shaft 7, a gear pair 23 provided between the engine output shaft 7 and the second component transmission shaft 5, and the second component transmission shaft 5 are likewise illustrated in bold in all of FIGS. 1 to 13. This is intended to indicate which components of the transmission have been or are driven in each case. The fact that the gear pair 23 is located between the second component transmission shaft 5 and the engine output shaft 7 does not change anything regarding the fact that the second component transmission shaft 5, as described above is directly connected to the engine output shaft 7 since it is intended to be stated by the term “directly” that the connection does not take place via the friction clutch 6.

In the state of the transmission 1 of FIG. 3, the friction clutch 6 is closed or is in engagement, and therefore the drive takes place via the engine output shaft 7, the friction clutch 6, the first transmission input shaft 9, a gear pair 24 connecting the first transmission input shaft 9 to the component transmission shaft 4 of the first component transmission 2, the first component transmission shaft 4, the first gear step 11a and the transmission output shaft 8. The components mentioned are therefore likewise marked in bold in FIG. 3 in addition to the components marked in bold in FIG. 2. As explained above, the friction clutch 6 takes over the task here, in a manner known per say, of adapting the rotational speed of the transmission output shaft 8 to the rotational speed of the engine output shaft 7.

In the shifting state of FIG. 4, in addition to the engaged first gear step 11a in the first component transmission 2, in the second component transmission 3 the first gear step 11b is also engaged, by actuation of the shifting element 19b. Since the second component transmission shaft 5 is directly connected to the engine output shaft 7 via the gear pair 23, the drive of the transmission output shaft 8 can take place in this case both via the first component transmission 2 and via the second component transmission 3. This is illustrated in turn by solid lines. Since the two first gear steps 19a and 19b in the two component transmissions 2 and 3 have exactly the same transmission ratio, this double drive of the transmission output shaft 8 via the two component transmissions 2 and 3 is easily possible.

In the shifting state of FIG. 5, the friction clutch 6 has been released or opened, and therefore the first component transmission shaft 4 is no longer connected to the engine output shaft 7. In this case, the driving of the transmission output shaft 8 by the engine output shaft 7 therefore takes place exclusively via the second component transmission shaft 5. This therefore involves a direct drive of the transmission output shaft 8 without the use of the friction clutch 6. This is illustrated in turn by corresponding bold lines.

According to FIG. 6, after the friction clutch 6 in the first component transmission 2 is opened by corresponding actuation of the associated shifting element 19a, the first gear step 11a is also released, and therefore, in the first component transmission 2, no gear is engaged.

In the shifting state of FIG. 7, the driving of the transmission output shaft 8 furthermore takes place via the second component transmission shaft 5 and the first gear step 11b of the second component transmission 3. However, in contrast to FIG. 6, in the first component transmission 2, the second gear step 12a has been engaged, by actuation by means of the shifting element 20a. Since the friction clutch 6 is not closed, this is irrelevant, however, for the driving of the transmission output shaft 8. On the contrary, a changing over of the transmission 1 from the first gear step 11b of the second component transmission 3 to the second gear step 12a of the first component transmission 1 is provided in this manner. Since the drive, as mentioned, furthermore also takes place via the second component transmission 3, the corresponding components used for the drive are in turn marked in bold.

In the shifting state of the transmission 1 of FIG. 8, the shifting element 19b is deactivated at the same time as the friction clutch 6 is closed, and therefore, in the second component transmission 3, the first gear step 11b is disengaged, and the second component transmission 3 is in the neutral position. By closing the friction clutch 6 and simultaneously disengaging or releasing the first gear step 11b in the second component transmission 3, the drive of the transmission output shaft 8 takes place via the first component transmission 2. In the present case, the drive of the transmission output shaft 8 to the transmission output shaft 8 therefore takes place via the engine output shaft 7, the friction clutch 6, the first transmission input shaft 9, the gear pair 24, the first component transmission shaft 4 and the second gear step 12a. The parts mentioned are in turn illustrated in bold. As mentioned, in this state, the transmission output shaft 8 is not driven via the second component transmission shaft 5 of the second component transmission 3 since the second component transmission 3 is in the neutral position.

In the shifting state of FIG. 9, in the second component transmission 3, the second gear step 12b has been activated or engaged by means of the shifting element 20. This takes place in principle analogously to the shifting state of FIG. 4 where the first gear step 11b has been engaged by means of the shifting element 19b in the second component transmission 3. The transmission output shaft 8 is therefore connected in turn to the engine output shaft 7 both via the first component transmission shaft 4 and via the second component transmission shaft 5. As in the preceding figures, the components involved in the drive are marked in bold.

Analogously to the procedure of FIG. 5, according to FIG. 10 the friction clutch 6 is released and the drive of the motor vehicle takes place exclusively via the second component transmission shaft 5 and the second gear step 12b to the transmission output shaft 8 directly and without the use of the friction clutch.

Subsequently, as illustrated in FIG. 1, the shifting element 20a is brought into its neutral position, and therefore no gear pair is in engagement in the first component transmission shaft 4 and the first component transmission 2 is in the neutral position. This takes place in turn analogously to the procedure of FIG. 6.

In the shifting state of FIG. 12, the shifting element 20a has been brought into a position in which it actuates the third gear step 13a of the first component transmission 2. Therefore, in the second component transmission 3, the second gear step 12b is engaged and, in the first component transmission 2, the third gear step 13a is engaged in order, analogously to FIG. 7, to provide the changing over of the transmission 1 from the second gear step 12b of the second component transmission 3 to the third gear step 13a of the first component transmission 1. Since the friction clutch 6 is still disengaged, the drive also continues to take place to the transmission output shaft 8 only via the second component transmission shaft 5 and the second gear step 12b.

Finally, the step illustrated in FIG. 13 takes place, in which the shifting element 20b of the second component transmission 3 is released simultaneously with the closing of the friction clutch 6, and therefore, in the second component transmission 3, the second gear step 12b is disengaged and, since the third gear step 13a has already been engaged in the second component transmission 3, the drive of the motor vehicle to the transmission output shaft 8 takes place via the friction clutch 6, the first component transmission shaft 4 and the third gear step 13a. The further shifting operations can be carried out in a similar manner, wherein the downshift is carried out in a reverse sequence.

The automatization of all of the shifting operations by means of a control device (not illustrated in the figures) can take place in a manner known per se and is therefore not described in detail.

In principle, it is possible, directly after a shifting operation and the engagement of the corresponding gear step in the second component transmission 3, to release the friction clutch 6 and to drive the transmission output shaft 8 exclusively via the directly driven second transmission input shaft 10. However, it is then necessary to actuate the shifting element 19b to 22b, which is assigned to the respective gear step 11b to 17b, in order to ensure that the respective gear step 11 to 17 is not automatically released. It is also thereby possible to reach a more rapid shifting time and possibly to protect the friction clutch 6. This is also conceivable in the embodiments of the transmission 1 that are described below. Depending on which of the strategies described is used, the components of the component transmission 2 or 3, which is used only for shifting operations, may possibly be formed with smaller dimensions.

FIGS. 14 to 25 illustrate an alternative embodiment of the transmission 1. The transmission 1 again has the two component transmissions 2 and 3 with the respective component transmission shafts 4 and 5, the friction clutch 6, the engine output shaft 7, the transmission output shaft 8, the first transmission input shaft 9 and the second transmission input shaft 10. However, in contrast to the embodiment according to FIGS. 1 to 13, the two component transmissions 2 and 3 do not have all of the gear steps. Since all of the gear steps are only present once, said gear steps have been denoted in the embodiment of FIGS. 14 to 25 by the reference signs 11 to 18. In the present case, the second gear step 12, the fourth gear step 14, the sixth gear step 16 and the gear step 18 for the reverse gear are present in the first component transmission 2, whereas the first gear step 11, the third gear step 13, the fifth gear step 15 and the seventh gear step 17 are arranged in the second component transmission 3. For shifting sequence reasons, this assignment of the gear steps 11 to 18 to the two component transmissions 2 and 3 has proven expedient, but it is also possible, of course, to assign the gear steps 11 to 18 to the two component transmissions 2 and 3 in another manner.

In order also in this embodiment to drive in each case one component transmission 2 or 3 via the friction clutch 6 and the other component transmission 3 or 2 directly via the engine output shaft 7, the second transmission input shaft 10 can be brought into operative connection with the first component transmission shaft 4 via first transmission means 25 and a shifting element 26 which is operatively connected thereto, and with the second component transmission shaft 5 via further transmission means 27 and a shifting element 28 which is operatively connected thereto. In a similar manner, the first transmission input shaft 9, which is connected to the friction clutch 6, can be brought into operative connection with the first component transmission shaft 4 via first transmission means 29 and a shifting element 30 which is operatively connected thereto, and with the second component transmission shaft 5 via further transmission means 31 and a shifting element 32 assigned to same. The shifting elements 26 and 28 which are operatively connected to the transmission means 25 and 27 are also designed here as form-fitting, force-actuated shifting elements which are deactivated when the actuating force acting thereon ceases. As already mentioned above, said form-fitting shifting elements 26 and 28 can be claw clutches, which, as mentioned above, is described in more detail with reference to FIG. 25. In the present case, the transmission means 25, 27, 29 and 31 are designed as gear pairs, wherein one of the gear wheels is arranged on the first transmission input shaft 9 or on the second transmission input shaft 10 and the other gear wheel is arranged on the first component transmission shaft 4 or on the second component transmission shaft 5.

In the case of the transmission 1 illustrated in FIGS. 14 to 24, it is possible to connect the engine output shaft 8 via the friction clutch 6 and one of the two transmission input shafts 9 or 10 alternatively to one of the two component transmissions 2 or 3 and to connect the other component transmission 3 or 2 via the other of the two transmission input shafts 10 or 9 directly to the engine output shaft 7.

In a similar manner as described with reference to FIGS. 1 to 13, the gear steps 11 to 18 are also provided with respective shifting elements which are capable of engaging or disengaging the individual gear steps 11 to 18. In the present case, the first gear step 11 and the third gear step 13 are assigned a common shifting element 33, the gear step 18 for the reverse gear and the second gear step 12 are assigned a common shifting element 34, the fourth gear step 14 and the sixth gear step 16 are assigned a common shifting element 35, and the fifth gear step 15 and the seventh gear step 17 are assigned a common shifting element 36. The shifting elements 33 to 36 mentioned can be designed in a manner known per se and serve, as mentioned, to engage or to release the respective gear step 11 to 18. In contrast to the transmission 1 which is described with reference to FIGS. 1 to 13 and in which the shifting elements 19b to 22b are designed as form-fitting shifting elements, the shifting elements 33 to 36 of the transmission 1 described with reference to FIGS. 14 to 24 and are provided with synchromesh mechanisms and the like. In contrast to the shifting elements 26 and 28 acting on the transmission means 25 and 27, which are connected to the second transmission output shaft 10, the two shifting elements 30 and 32 acting on the transmission means 29 and 31, which are connected to the first transmission input shaft 9, are also provided with synchromesh mechanisms.

Shifting operations in the transmission 1 of this embodiment, the transmission having the two component transmissions 2 and 3, will now be explained by way of example with reference to FIGS. 14 to 25, similarly as with reference to FIGS. 1 to 13.

FIG. 14 shows the inoperative state of the transmission 1 in which a gear step is not engaged in any of the two component transmissions 2 and 3.

In the shifting state of FIG. 15, the two shifting elements 30 and 32 of the two transmission means 29 and 31 have been actuated such that the first transmission input shaft 9, which originates from the friction clutch 6, is connected to the two component transmission shafts 4 and 5. The friction clutch 6 can be in the open or the closed position here since a gear step is not engaged in any of the two component transmissions 2 or 3. This state can be referred to as the basis position.

In the shifting state of FIG. 16, the first gear step 11 has been engaged in the second component transmission 3 by means of the shifting element 33 assigned to the first gear step 11. Since the friction clutch 6 also continues to be open, the transmission output shaft 8 is nevertheless not driven by the engine output shaft 7.

The friction clutch is closed in accordance with FIG. 17, as a result of which a drive of the transmission output shaft 8 is produced via the friction clutch 6, the first transmission input shaft 9, the transmission means 31, the second component transmission shaft 5 and the first gear step 11. In this case, the motor vehicle is therefore driven and is moved in the first gear step 11.

In the shifting state of FIG. 18, the shifting element 28 assigned to the transmission means 27 has been actuated in order to bring the transmission means 27 into engagement and therefore, in addition to the drive already present via the friction clutch 6 and the first transmission input shaft 9, additionally also to drive the second component transmission shaft 5 via the second transmission input shaft 10, which is directly connected to the engine output shaft 7. In addition to the above-described drive of the second component transmission shaft 5 via the friction clutch 6, the first transmission input shaft 9 and the transmission means 31, in this case the drive of the transmission output shaft 8 therefore also takes place via the second transmission input shaft 10, which is directly connected to the engine output shaft 7, and the transmission means 27.

In the shifting state of FIG. 19, the friction clutch 6 has been opened and the drive of the transmission output shaft 8 to the engine output shaft 7 takes place exclusively via the second transmission input shaft 10, the transmission means 27, the second component transmission shaft 5 and the first gear step 11. Accordingly, analogously to the above-described shifting state of FIG. 5, this involves a direct drive of the transmission output shaft 8 without the use of the friction clutch 6.

In the shifting state of FIG. 20, the shifting element 32 has been opened or brought into its neutral position, and therefore the first transmission input shaft 9 would no longer be connected to the second component transmission shaft 5 even in the closed state of the friction clutch 6.

FIG. 21 shows a shifting state in which the second gear step 12 has been engaged in the first component transmission 2 by means of the shifting element 34. Since the friction clutch 6 continues to be open, this second gear step 12 is not, however, connected to the transmission output shaft 8. On the contrary, this serves as preparation in order, in a subsequent step, to shift the transmission 1 into the second gear step 12.

This subsequent step is illustrated in FIG. 22 in which, in principle, analogously to the procedure of FIG. 8, the friction clutch is closed and at the same time the shifting element 28 acting on the transmission means 27 is opened such that the connection between the second transmission input shaft 10, which bypasses the friction clutch 6 and is directly connected to the engine output shaft 7, and the second component transmission shaft 5 is interrupted. This automatic release of the shifting element 28 is ensured by the embodiment of the form-fitting, force-actuated shifting element 28 that is described, as mentioned above, with reference to FIG. 25.

In the shifting state of FIG. 23, by corresponding actuation of the shifting element 33, the first gear step 11 in the second component transmission 3 has been disengaged, and therefore the drive of the transmission output shaft 8 takes place, as also in the case of FIG. 22, exclusively via the friction clutch 6, the first transmission input shaft 9, the transmission means 29, the first component transmission shaft 4 and the second gear step 12.

In the shifting state of FIG. 24, the transmission means 31 has been brought, by actuation thereof, into engagement with the shifting element 32. A subsequent changing over of the transmission to the third gear step 13, which is assigned to the second component transmission 3, is thereby provided.

The further shifting operations, which can be carried out with the embodiment of the transmission 1 that is illustrated in FIGS. 14 to 24, are produced analogously to the above-described shifting operations during the changing over from the first gear step 11 into the second gear step 12, wherein the downshifting is carried out in the reverse sequence.

FIG. 25 illustrates by way of example a claw clutch which can be used both for the shifting elements 19b, 20b, 21 b and 22b of the first embodiment of the transmission 1 that is described with reference to FIGS. 1 to 13 and for the shifting elements 26 and 28 of the second embodiment of the transmission 1 that is described with reference to FIGS. 14 to 24. It can be seen that this is part of a claw clutch with two clutch halves, in which a projection 37 of the one clutch half 38 engages in a recess 39 of a second clutch half 40, wherein there is a form-fitting connection between the projection 37 and the recess 39. A multiplicity of such projections 37 and recesses 39 are preferably provided around the circumference of the claw clutch. The projection 37 and the recess 39 have mutually corresponding oblique surfaces, the angle of which is oriented or selected in such a manner that, when the actuating force ceases, the two clutch halves 38 and 40 are released from each other and are not clamped to each other. For this purpose, the projection 37 tapers in the direction of the recess 39. Accordingly, the recess 39 widens in the direction of the projection 37. The angle denoted by “α” on the tension side of the claw clutch, that is the angle at the left end of the projection 37 and the recess 39 in the exemplary embodiment illustrated, can be between 30 and 450 depending on the torque to be transmitted. A larger angle α on the tension side requires a greater force in order to keep the claw clutch in its closed state. Angles between 30 and 100 are therefore preferred. This also facilitates the release of the claw clutch and greater shifting comfort is produced.

In the exemplary embodiment illustrated in FIG. 25, the angle denoted by “β” on the thrust side of the claw clutch, i.e. the angle at the right end of the projection 37 or of the recess 39 in the exemplary embodiment illustrated, is substantially equal to the angle α. i.e. it can likewise be between 3° and 10°. The two angles α and β are illustrated in an exaggerated size in FIG. 25 in order to make the presence of said angles clearer. The force which acts from the upper clutch half 38 onto the lower clutch half 40 and is triggered by the torque is denoted in FIG. 25 by F_{T}, the force acting in the axial direction is denoted by F_{A} and the resulting force by F_{R}.

The automatic release of the two clutch halves 38 and 40 from each other takes place by means of the component F_{A}, which acts in the axial direction, of the force which acts on the two clutch halves 38 and 40 and arises because of the above-described angle α and the resulting oblique surfaces. The force acting on at least one of the two clutch halves 38 and 40 is preferably applied hydraulically. Of course, instead of a corresponding hydraulic cylinder, use may also be made of an electric motor in order to electrically adjust the shifting elements.

An alternative embodiment of the claw clutch which can be used for the shifting elements 19b, 20b, 21b, 22b, 26 and 28 is described in FIG. 26. While, in this embodiment, the angle α on the tension side of the respective projections 37 can be identical to the angle α according to FIG. 25, the angle β on the thrust side of the respective projections 37 can be substantially larger and can be, for example, between 45° and 60°.

FIGS. 27, 28 and 29 illustrate various embodiments of the claw clutch which can be used for the shifting elements 19b, 20b, 21b, 22b, 26 and 28. As can be seen, the projections 37 and the corresponding recesses 39 can be symmetrical or asymmetrical shapes. Of course, other embodiments of the projections 37 and of the corresponding recesses 39 are also conceivable. A common feature of all of the embodiments is that they are suitable for forming the form-fitting, force-actuated shifting elements 19b to 22b, 26 and 28 which are deactivated when the actuating force ceases and with which the transmission output shaft 8 can be brought into operative connection with the engine output shaft 7 via at least one of the component transmission shafts 4, 5.

Instead of the claw clutch, suitable toothings could also be used for the shifting elements 19b, 20b, 21b and 22b or 26 and 28. Furthermore, it is also conceivable in principle not to design the shifting elements 19b, 20b, 21b and 22b or 26 and 28 as form-fitting, force-actuated shifting elements, but rather to use a device which brings the corresponding shifting elements into their position which does not actuate the respective gear step.

With such an embodiment of the shifting elements 19b, 20b, 21b, 22b, 26 and 28 as a claw clutch with the projections 37 and recesses 39, a free wheel can be simulated since, during the change into a higher gear step, the lower gear rolls over and is disengaged during the closing of the friction clutch 6. A very high shifting comfort is produced as a result. In principle, in the case of hydraulic actuation of the claw clutch, two different pressure levels can also be used such that simpler changes of gear are possible.

FIGS. 30 to 34 illustrate various illustrative torque profiles during upshifting from a gear step 11 to 16 into one of the gear steps 12 to 17 of one of the hereindescribed transmissions 1. The torque applied to the first transmission input shaft 9 or to the second transmission input shaft 10 is plotted here in each case as a percentage of the maximum torque over time in milliseconds. The graph indicated by “A” shows in each case the torque profile of the transmission input shaft 9 or 10, which is directly connected to the engine output shaft 7, while the graph denoted by “B” shows the torque profile of the transmission input shaft 9 or 10 which is connected to the friction clutch 6.

In the case of the profile of FIG. 30, it can be seen that the torque at the transmission input shaft 9 or 10 connected to the friction clutch 6 is built up only when torque is no longer applied at the transmission input shaft 9 or 10 directly connected to the engine output shaft 7. In the case of this procedure which is very careful or conservative in respect of possible problems, a changing-over time of approx. 50 ms is produced.

In the case of the procedure of FIG. 31, the friction clutch 6 is already brought into engagement at a time at which the full torque is still applied at the transmission input shaft 9 or 10 directly connected to the engine output shaft 7. The shifting element 19b, 20b, 21b, 22b, which is assigned to the corresponding gear, in the embodiment of FIGS. 1 to 13 or the shifting element 26 or 28, which is assigned to the transmission input shaft 9 or 10 directly connected to the engine output shaft 7, in the embodiment of FIGS. 14 to 24 is accordingly deactivated only when the friction clutch 6 is in engagement. A less conservative changing-over strategy is involved here, in which the shifting time is approx. 35 ms.

An optimized shifting strategy is illustrated in FIG. 32. The friction clutch 6 here is already in engagement before the torque at the transmission input shaft 9 or 10 directly connected to the engine output shaft 7 is reduced. This results in a shifting time of approx. 10 ms from the beginning of the reduction of the torque of the transmission input shaft 9 or 10, which is directly connected to the engine output shaft 7, until the desired torque, which is lower because of the upshifting into a higher gear step, is achieved at the transmission input shaft 9 or 10 connected to the friction clutch 6. At this short shifting time, there is in principle no traction force interruption.

As is apparent from the shifting strategy of FIG. 33, it is possible, in order to bypass possible problems during the upshifting, for the torque of the transmission input shaft 9 or 10, which is directly connected to the engine output shaft 7, to be reduced even before the shifting operation. This takes place by means of a reduction in the torque of the driving engine having the engine output shaft 7, which may be, for example, an internal combustion engine, but also an electric motor.

A further diagram of an illustrative torque profile during upshifting is illustrated in FIG. 34. The torque profile of the transmission input shaft 9 or 10 directly connected to the engine output shaft 7 is again illustrated by means of the graph denoted by “A” and the torque profile at the transmission input shaft 9 or 10 connected to the friction clutch 6 is illustrated by the graph denoted by “B”. The graph indicated by “C” denotes the torque profile at the transmission output shaft 8. It can be seen that by the drive being taken over by the direct drive during the shifting of the friction clutch 6, no traction force interruption at all takes place and that the torque applied to the transmission output shaft 8 drops linearly and without disturbances from the higher level of the lower gear step to the lower level of the higher gear step.

FIG. 35 shows a diagram in which an illustrative torque profile is illustrated during downshifting from one of the gear steps 12 to 17 into one of the gear steps 11 to 16 of one of the hereindescribed transmissions 1. This shifting strategy corresponds in principle to the shifting strategy, which is illustrated in FIG. 32, during upshifting, i.e. a very shorting shifting time is achieved. The torque at the transmission input shaft 9 or 10 directly connected to the engine output shaft 7 is again illustrated by the graph “A”, and the torque at the transmission input shaft 9 or 10 connected to the friction clutch 6 is illustrated by the graph “B”. Of course, the shifting strategies described above with reference to FIGS. 30, 31, 32 and 33 can also be transferred to the shifting strategy during downshifting.

In the embodiment of the transmission 1 according to FIG. 36, there is a third component transmission 41 in addition to the two component transmissions 2 and 3 of the embodiment illustrated in FIGS. 14 to 24. The gear steps 11 to 18 are again provided here, wherein the first gear step 11 and the gear step 18 for the reverse gear are arranged directly on the engine output shaft 7. The fourth gear step 14 and the seventh gear step 17 are arranged on the first component transmission shaft 4 of the first component transmission 2, the third gear step 13 and the sixth gear step 16 are arranged on the second component transmission shaft 5 of the second component transmission 3, and the second gear step 12 and the fifth gear step 15 are arranged on a third component transmission shaft 42 of the third component transmission 41.

As described with reference to FIGS. 14 to 24, the transmission means 25, 27, 29 and 31 are also provided here with the shifting elements 26, 28, 30 and 32 assigned thereto. In addition, for the third component transmission 41, a transmission means 43 connected to or cooperating with the second transmission input shaft 10 is provided with a shifting element 44 assigned thereto, and a transmission means 45 connected to the first transmission input shaft 9 is provided with a shifting element 46 assigned thereto. In this embodiment, the first transmission input shaft 9 can therefore be brought into operative connection with the three component transmission shafts 4, 5 and 41 via the transmission means 29, 31 and 45 and the shifting elements 30, 32 and 46 assigned thereto. The second transmission input shaft 10 can be brought into operative connection with the three component transmission shafts 4, 5 and 41 via the transmission means 25, 27 and 43 and the shifting elements 26, 29 and 44 assigned thereto.

Of course, the third component transmission 41 is not arranged in a plane with the two component transmissions 2 and 3, as is illustrated in FIG. 31, but is offset spatially from the plane of the page. This is indicated by the arrows “C”. In principle, the three component transmissions 2, 3 and 41 are arranged in the manner of a triangle.

Analogously to the embodiment of FIGS. 14 to 24, each of the gear steps 11 to 17 is also assigned a corresponding shifting element here. In order to actuate the two gear steps 14 and 17 of the first component transmission 2, a shifting element 47 is provided, in order to actuate the two gear steps 13 and 16 of the second component transmission 3, a shifting element 48 is provided, and in order to actuate the two gear steps 12 and 15 of the third component transmission 41, a further shifting element 49 is provided. The manner of operation of the shifting elements 47, 48 and 49 corresponds to that of the shifting elements 33 to 36 of the embodiment of the transmission 1 that is illustrated in FIGS. 14 to 24.

The transmission 1 illustrated in FIG. 36 with the three component transmissions 2, 3 and 41 can be operated in principle analogously to the transmission 1, which is illustrated in FIGS. 14 to 24, with the two component transmissions 2 and 3. However, during each shifting operation, a greater selection of changes of gear is possible since a change can be made from each of the component transmissions 2, 3 and 41 into each other component transmission 2, 3 and 41, i.e. two component transmissions are always available in which a change of gear can take place. As a result, greater flexibility in the changing of gear is possible. In addition to the third component transmission 41, it is conceivable also to provide further component transmissions.

FIG. 37 illustrates a further embodiment of the transmission 1. This is a modified form of the embodiment of the transmission 1 that is illustrated in FIGS. 14 to 24 but in which the two transmission input shafts 9 and 10 are each connected to two additional transmission means which have different transmission ratios. In principle, the transmission means 25, 27, 29 and 31 present in the embodiment of FIGS. 14 to 24 are replaced by two transmission means in each case.

Specifically, the second transmission input shaft 10 is in each case assigned two transmission means 50 and 51 which have a low transmission ratio and two transmission means 52 and 53 which have a higher transmission ratio. The transmission means 50 and 52 can be changed over by means of a shifting element 54 arranged between same. Analogously thereto, the transmission means 51 and 53 can be changed over by means of a shifting element 55 arranged between same. While the two transmission means 50 and 52 are assigned to the first component transmission shaft 4 of the first component transmission 2, the two transmission means 51 and 53 are assigned to the second component transmission shaft 5 of the second component transmission 3. Furthermore, the first transmission input shaft 9 is assigned respective transmission means 56 and 57 with a low transmission ratio and respective transmission means 58 and 59 with a higher transmission ratio. Like the transmission means 50, 51, 52 and 53, a change can be made between the two transmission means 56 and 58 by means of a shifting element 60 and between the two transmission means 57 and 59 by means of a shifting element 61 in order to change over from the lower transmission ratio into the higher transmission ratio and vice versa.

By means of this design of the transmission 1 according to FIG. 37, the number of gear steps to be shifted can be doubled. It is possible here to combine the individual gear steps 11 to 18 with the additional transmission means 50 to 53 and 56 to 59 in the manner of a range transmission or in the manner of a split transmission. Of course, this embodiment in which the transmission means 50 to 53 and 56 to 59 are present with the different transmission ratios in each case can also be used with the transmission 1 described with reference to FIGS. 1 to 13.

FIG. 38 shows a further embodiment of the transmission 1 which is suitable for certain construction space conditions in motor vehicles. In principle, the embodiment of FIG. 38 is a modification of the embodiment of the transmission 1 that is illustrated in FIGS. 14 to 24, and therefore mutually corresponding components are provided with the same reference signs. Certain components of the transmission, such as, for example, the shifting elements 26 and 28, are arranged here at positions within the transmission 1 at which they do not require any additional construction space, i.e. at locations at which there is construction space since said locations are not used by other components. As a result, both the length and the width of the entire transmission 1 can be reduced. The two transmission output shafts 8 lead here to a differential 62, the function of which is known per se and is therefore not described in more detail here.

1. A transmission comprising:
at least two component transmissions which have respective component transmission shafts and individual gear steps and which are further shiftable independently of one another, and wherein the transmission further has a friction clutch, having an engine output shaft which is connected to the friction clutch; a first transmission input shaft originating from the friction clutch; a second transmission input shaft which bypasses the friction clutch and is directly connected to the engine output shaft; and a transmission output shaft, and wherein the transmission output shaft can be brought into operative connection with the engine output shaft via at least one of the component transmission shafts by means of one of a plurality of form-fitting, force-actuated shifting elements which are deactivated when an actuating force ceases.

2. The transmission as claimed in claim 1, and wherein the individual gear steps of at least the second component transmission are assigned respective form-fitting, force-actuated shifting elements.

3. The transmission as claimed in claim 1, and wherein the second transmission input shaft can be brought into operative connection with the at least two component transmission shafts via the respective transmissions and the form-fitting, force-actuated shifting elements which are operatively connected thereto.

4. The transmission as claimed in claim 3, and wherein the transmission means are designed as gear pairs.

5. The transmission as claimed in claim 4, and wherein the form-fitting shifting elements are designed as claw clutches.

6. The transmission as claimed in claim 5, and wherein the form-fitting shift elements each have two clutch halves with projections and recesses engaging in the projection.

7. The transmission as claimed in claim 6, and wherein the projections taper in the direction of the recesses.

8. The transmission as claimed in claim 7, and wherein each of the projections are defined by several sides, and wherein those sides of the projections which face the recesses have an angle of 3-45° on a tension side of the shifting element.

9. The transmission as claimed in claim 8, and wherein the first transmission input shaft and the second transmission input shaft are arranged coaxially one in the other.

10. The transmission as claimed in claim 9, and wherein three or more component transmissions are provided with respective component transmission shafts, and wherein the second transmission input shaft can be brought into operative connection with the three or more component transmission shafts via the respective transmission means and shifting elements in operative connection therewith.

11. The transmission as claimed in claim 10, and wherein the two transmission input shafts are each connected to at least two transmission means which have different transmission ratios.

12. The transmission as claimed in claim 10, and wherein the transmission output shaft is brought into operative connection with the engine output shaft via at least one of the component transmission shafts by means of the respective form-fitting, force-actuated shifting elements which are deactivated when the actuating force ceases, and wherein, in a state in which a gear step is engaged in the component transmission which is connected to the friction clutch, and the friction clutch is open, the transmission output shaft is driven directly via the transmission input shaft and which bypasses the friction clutch and is connected directly to the engine output shaft, and wherein, when the friction clutch is closed, the gear step engaged in the component transmission, which is connected directly to the engine output shaft, is disengaged.

13. The transmission as claimed in claim 12, and wherein directly after a shifting operation and the engagement of a gear step in the component transmission which is connected directly to the engine output shaft, the friction clutch is opened and the transmission output shaft is driven exclusively via the transmission input shaft, and which is connected directly to the engine output shaft.

14. The transmission as claimed in claim 13, and wherein a gear step is engaged in the component transmission, which is connected directly to the engine output shaft only immediately before a shifting operation, and in that, directly after a shifting operation in the component transmission which is connected directly to the engine output shaft, the gear step is disengaged.
